(19) United States
(12) Patent Application Publication
(10) Pub. No.: US 2011/0050606 A1
(43) Pub. Date: Mar. 3, 2011

(54) PORTABLE ELECTRONIC DEVICE

(75) Inventors: SHI-PEI ZHANG, Shenzhen City (CN); MAN-ZHONG WANG, Shenzhen City (CN); TE-HUA LEE, Tu-Cheng (TW)

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/833,333

(22) Filed: Jul. 9, 2010

(30) Foreign Application Priority Data
Aug. 27, 2009 (CN) 200910306146.8

(51) Int. Cl. G06F 3/041

(52) U.S. Cl. 345/173

(57) ABSTRACT

A portable electronic device includes a main body and a frame. The main body includes a front shell, a back shell engaging with the front shell, and a touch panel mounted on the back shell. The frame is mounted on the back shell. The touch panel is surrounded by the frame. The frame extends beyond the surface of the touch panel.

### BACKGROUND

1. Technical Field

The disclosure relates to portable electronic devices, particularly to a portable electronic device with a table-top support structure.

2. Description of Related Art

Portable electronic devices, such as cell phones, multimedia players, cameras, personal digital assistants and so on, play a very important role in most people's lives. Most portable electronic devices are equipped with a touch panel on the back surface thereof for convenience in using the electronic device. The surface of the touch panel is usually a planar smooth surface. However, in use, the surface of the touch panel of the electronic devices are prone to scratch and abrasion when contacting rough surfaces. The scratched and abraded touch panel surface degrades the smooth surface and response performance of the portable electronic devices.

Therefore, it is desirable to provide a portable electronic device with a table-top support structure protecting the portable electronic device from scratch and abrasion when the portable electronic device is placed on a table or a support.

### BRIEF DESCRIPTION OF THE DRAWINGS

FIG. 1 is an isometric view of a portable electronic device in accordance with one embodiment.

FIG. 2 is an exploded view of the portable electronic device of FIG. 1.

FIG. 3 is another isometric view of the portable electronic device of FIG. 1.

FIG. 4 is an isometric view of a portable electronic device in accordance with another embodiment.

### DETAILED DESCRIPTION

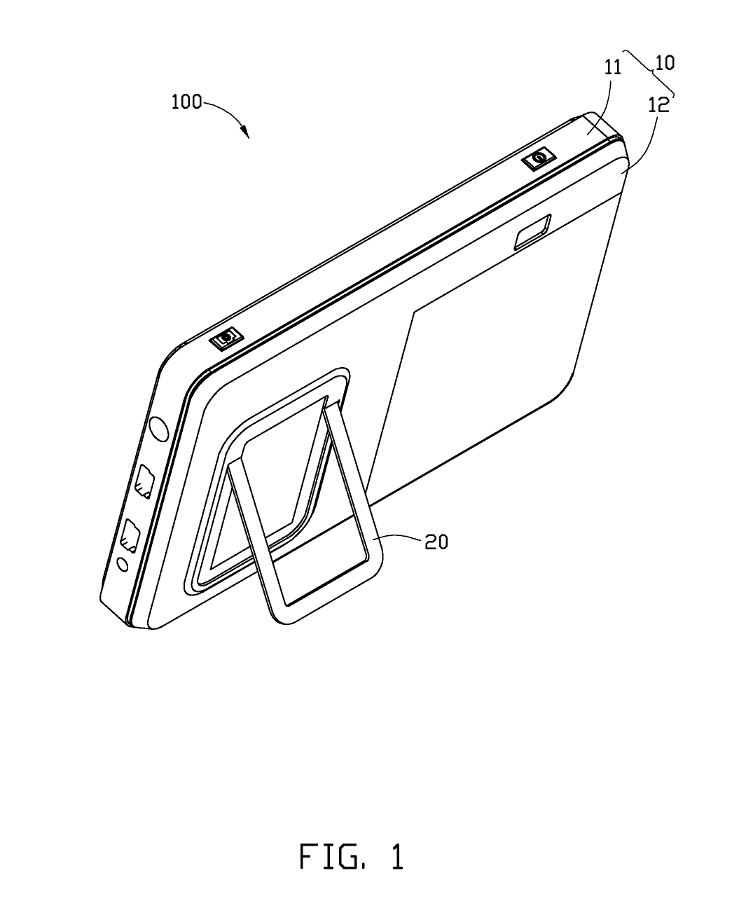

Referring to FIG. 1, one embodiment of a portable electronic device 100 includes a main body 10 and a table-top support structure 20 pivoted on a back surface of the main body 10.

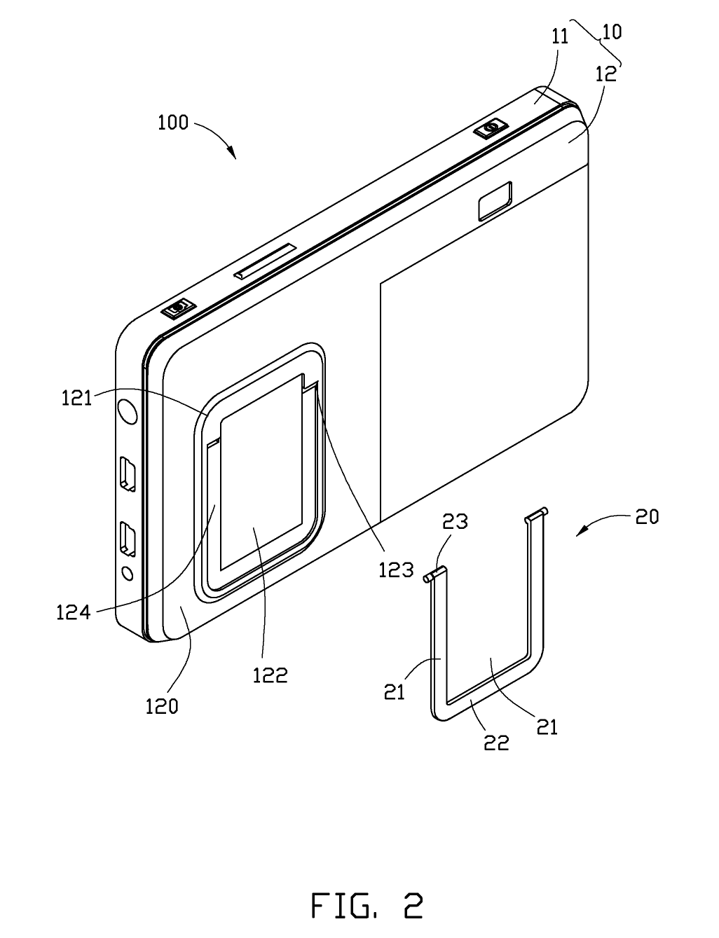

Referring to FIG. 2, the main body 10 includes a front shell 11 and a back shell 12 cooperatively forming a compartment for receiving electronic elements (not shown) of the portable electronic device 100 therein. The front shell 11 can have a display, control buttons, access interference, and other necessary elements (all not shown) installed for actualizing the necessary functions of the portable electronic device 100 formed thereon. The back shell 12 includes a surface 120 on which a frame 121 and a touch panel 122 are mounted. The touch panel 122 is surrounded by the frame 121. The surface of the touch panel 122 is below the top surface of the frame 121 such that the frame 121 appears protruding above the surface of the touch panel 122. The touch panel 122 is electrically connected to the electronic elements in the portable electronic device 100 to provide a touch control interface for users to use the device 100. A recess 124 is defined in the frame 121 surrounding portions of the touch panel 122 to form a space for receiving the table-top support structure 20. In the illustrated embodiment, the recess 123 is U-shaped, and two shaft holes 123 are symmetrically defined in opposite side walls of the recess 124 adjacent to the opening end of the U-shape recess for a shaft of the table-top support structure 20 to pivot.

The table-top support structure 20 corresponds to the shape of the recess 124 of the frame 121 and is capable of being wholly accommodated in the recess 124.

In the illustrated embodiment, the table-top support structure 20 is U-shaped and includes two legs 21, a connecting arm 22 interconnecting the legs 21, and a pair of shafts 23 symmetrically protruding outwards from the outer sides of the legs 21. The connecting arm 22 is substantially perpendicular to the legs 21. The shafts 23 are symmetrically formed on the legs 21 far away from the connecting arm 22, and can be received in the corresponding shaft holes 123 for rotatably connecting the table-top support structure 20 to the frame 121. The legs 21 and the connecting arm 22 can be made of elastic material that provides some flexibility for the legs 21.

In assembly, the legs 21 are pressed inwards until the shafts 23 are inserted into the shaft holes 123 of the frame 121. The pressed legs 21 are then released to restore automatically to its original shape due to the flexibility thereof. As such, the table-top support structure 20 is pivoted to the frame 121 of the main body 10.

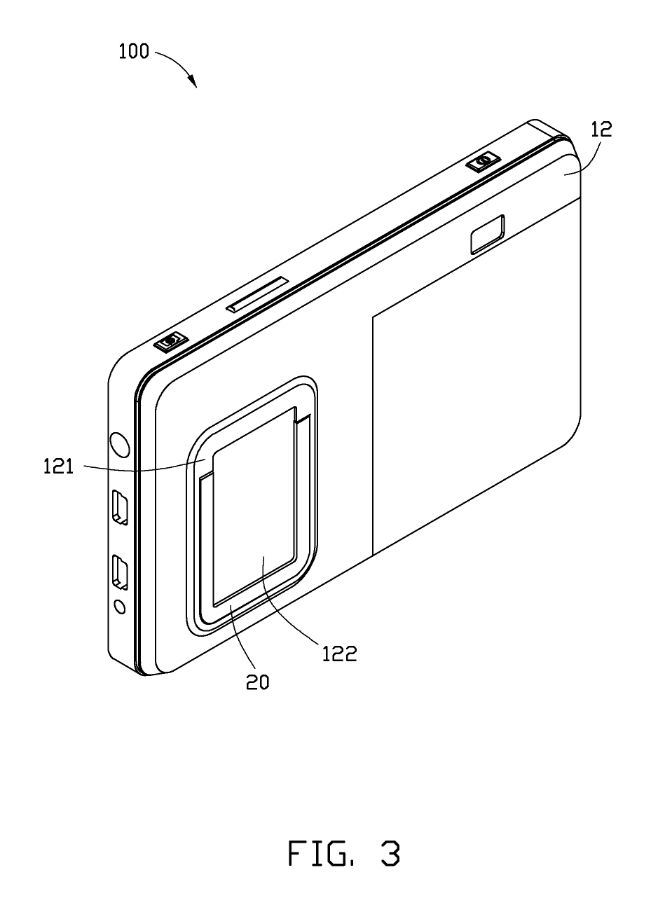

Referring to FIG. 3, the table-top support structure 20 can be received in the recess 121 for the convenience of carrying and transporting. The frame 122 protects the surface 120 of the back shell 12 and touch panel 122 from scratch and abrasion when the portable electrical device 100 is laid on a rough surface.

In addition, when standing the portable electrical device 100 on a table, the table-top support structure 20 is rotated out from the recess 124 until the table-top support structure 20 and the main body 10 of the portable electrical device 100 cooperatively form a stable triangular structure that will firmly support the portable electrical device 100 on the table.

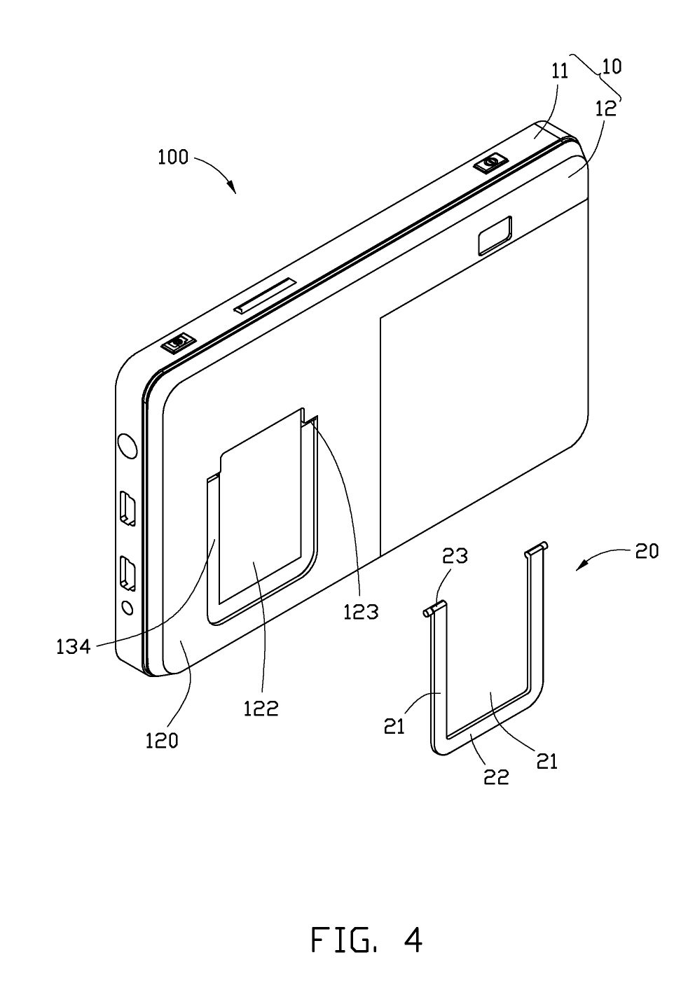

Referring to FIG. 4, the frame 121 of the main body 10 can be eliminated by directly forming a recess 134 in the back shell surrounding the touch panel 122. Similarly, the top surface of the table-top support structure 20 extends beyond the surface of the touch panel 122 when the table-top support structure 20 is received in the recess 124.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the disclosure.

What is claimed is:

1. A portable electronic device comprising:
a main body comprising a front shell, a back shell engaged with the front shell, and a touch panel mounted on the back shell; and
a frame mounted on the back shell, extending beyond the touch panel, and surrounding the touch panel.

2. The portable electronic device of claim 1, further comprising a table-top support structure rotatably mounted on the frame and capable of being received in the frame, wherein the table-top support structure surrounds a portion of the touch panel when received in the frame.

3. The portable electronic device of claim 2, wherein the frame defines a U-shaped recess surrounding the portion of the touch panel for receiving the table-top support structure.

4. The portable electronic device of claim 3, wherein the frame defines two shaft holes in opposite side walls of the recess adjacent to opening ends of the recess; the table-top support structure comprises two symmetric shafts corresponding to and inserting into the shaft holes of the frame, rotatably connecting the table-top support structure to the frame.

5. The portable electronic device of claim 4, wherein the table-top support structure is wholly accommodated in the recess and capable of being rotated out of the recess to support the portable electronic device.

6. The portable electronic device of claim 4, wherein the table-top support structure comprises two legs and a connecting arm interconnecting the legs; the shafts are symmetrically mounted on outer sides of the legs.

7. The portable electronic device of claim 6, wherein the connecting arm is substantially perpendicular to the legs.

8. The portable electronic device of claim 7, wherein the shafts are symmetrically formed on the legs far away from the connecting arm.

9. The portable electronic device of claim 6, wherein the legs and the connecting arm are made of elastic material.

10. An portable electronic device comprising:
a main body comprising a front shell, a back shell engaged with the front shell, and a touch panel mounted on the back shell;
a recess defined on the back shell and surrounding the touch panel; and
a table-top support structure received in the recess and extending beyond a surface of the touch panel.

11. The portable electronic of claim 10, wherein the recess is U-shaped, and two shaft holes are symmetrically defined in opposite side walls of the recess at opening ends of the recess; the table-top support structure comprises two shafts that pivot in the shaft holes.

12. The portable electronic device of claim 11, wherein the table-top support structure comprises two legs and a connecting arm interconnecting the two legs; the shafts are symmetrically mounted on outer sides of the legs.

13. The portable electronic device of claim 12, wherein the connecting arm is substantially perpendicular to the legs.

14. The portable electronic device of claim 12, wherein the shafts are symmetrically formed on the legs far away from the connecting arm.

15. The portable electronic device of claim 11, wherein the legs and the connecting arm are made of elastic material.
